(19) United States
(12) Patent Application Publication
(10) Pub. No.: US 2014/0247458 A1
(43) Pub. Date: Sep. 4, 2014

(54) IMAGE FORMING APPARATUS, IMAGE FORMING METHOD, AND STORAGE MEDIUM

(71) Applicant: CANON KABUSHIKI KAISHA, Tokyo (JP)

(72) Inventor: Yasunori Kanai, Tokyo (JP)

(21) Appl. No.: 14/191,328

(22) Filed: Feb. 26, 2014

(30) Foreign Application Priority Data
Mar. 1, 2013 (JP) 2013-040461

(51) Int. Cl. G06K 15/00; G06F 3/12

(52) U.S. Cl. CPC G06K 15/408; G06F 3/1237
USPC 358/1.14

(57) ABSTRACT

An image forming apparatus configured to utilize a storage area to store an image includes a receiving unit configured to receive print job data for which a predetermined print method is designated. The predetermined print method is configured to enable a stored image to be printed according to a print instruction given for the image by a user after the image is stored in the storage area. A storing unit is configured to store the generated image of the page into the storage area so that the stored image of the page is printed according to the print instruction, and is configured to, if the generating unit fails to generate an image of a page from the print job data, control an image of another page that the generating unit successfully generates from the print job data so that the image of the another page is not printed.

### BACKGROUND

1. Field

The present subject matter relates to an image forming apparatus, an image forming method, and a storage medium.

2. Description of Related Art

Conventionally, a page description language (PDL) is commonly used as a format of print jobs transmitted from a client apparatus such as a computer to a printing apparatus. The printing apparatus typically includes a controller that interprets PDL to generate page images on a bitmap memory, and a printer that prints the page images on paper. When the printing apparatus receives a print job from a client apparatus, the controller interprets the print job to generate a page image of each page. The printer successively prints the generated page images.

The controller includes a module called interpreter which interprets a print job. The interpreter interprets PDL, and page images are generated based on the interpretation result.

Japanese Laid-Open Patent Application No. 2011-224830 discusses a print method that can print PDL with higher throughput by using limited resources of a printing apparatus. Japanese Laid-Open Patent Application No. 10-177464 discusses a print method that can perform proper error recovery processing even when an error occurs during PDL interpretation.

The techniques discussed in the foregoing conventional art quit the interpretation process (stop interpreting) and end the job at the point in time when a PDL interpretation error occurs. With a normal print method, pages generated before the occurrence of the PDL interpretation error are output. However, such pages are often discarded because the pages are incomplete as a product. In the case of a print method such as stored printing, page images are stored in a storage area of the printer. Since the unnecessary data is stored in the printing apparatus, a user's effort is needed to perform deletion processing on the stored data (delete the images of the incomplete pages).

### SUMMARY

The present subject matter is directed to a technique which can save a user from performing deletion processing on stored data of already generated pages when a PDL interpretation error occurs in a print method such as stored printing.

An image forming apparatus according to an aspect of the present subject matter is an image forming apparatus configured to utilize a storage area to store an image. The image forming apparatus includes a receiving unit configured to receive print job data for which a predetermined print method configured to enable a stored image to be printed according to a print instruction given for the image by a user after the image is stored in the storage area is designated as a print method, a generating unit configured to generate an image of a page from the print job data, and a storing unit configured to store the generated image of the page into the storage area so that the stored image of the page is printed according to the print instruction, wherein the storing unit is configured to, if the generating unit fails to generate an image of a page from the print job data, control an image of another page that the generating unit successfully generates from the print job data so that the image of the other page is not printed.

Further features of the present subject matter will become apparent from the following description of exemplary embodiments with reference to the attached drawings.

### BRIEF DESCRIPTION OF THE DRAWINGS

FIG. 1 is illustrates an example of a hardware configuration of an image forming apparatus.

FIGS. 2A and 2B illustrate an example software configuration of the image forming apparatus.

FIG. 3 illustrates an example of an error page to which error information is added.

FIG. 4 is an example flowchart of processing according to a first exemplary embodiment.

FIG. 5 illustrates an example error page print setting screen.

FIG. 6 illustrates an example of an output result of normal printing.

FIG. 7 illustrates an example of an output result of stored printing or RIP post-completion printing.

FIG. 8, composed of FIG. 8A and FIG. 8B, is a flowchart illustrating an example of processing according to a second exemplary embodiment.

FIG. 9 illustrates an example print setting screen of a generated page.

FIG. 10 illustrates an example page information addition setting screen of an error page.

FIG. 11 illustrates an example error page when page information is added.

FIG. 12 illustrates an example error page output method setting screen in the stored printing.

FIG. 13 illustrates an example job history screen.

FIG. 14 illustrates an example print job screen in the stored printing.

### DETAILED DESCRIPTION

Various exemplary embodiments, features, and aspects of the subject matter will be described in detail below with reference to the drawings.

An apparatus configuration of an image forming apparatus 100 according to an exemplary embodiment will be described below.

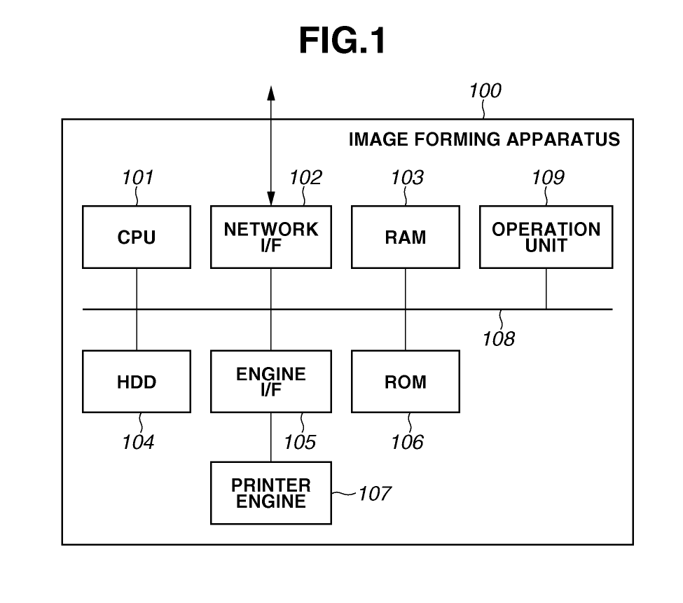

FIG. 1 is a diagram illustrating an example hardware configuration of the image forming apparatus 100.

A central processing unit (CPU) 101 performs control and calculation of various components in the image forming apparatus 100 and execution of programs stored in a storage device via a system bus 108. The CPU 101 executes programs stored in a hard disk drive (HDD) 104 to implement functions (software configuration) of the image forming apparatus 100 and processing according to flowcharts.

A random access memory (RAM) 103 is used as a temporary storage area and a work memory during a print operation of the image forming apparatus 100. The RAM 103 is an example of a storing unit.

The HDD 104 is a large-capacity storage device and contains various control programs to be executed by the CPU 101. The HDD 104 is also used as a temporary storage area of data to be processed and as a storage area for stored printing. The HDD 104 is an example of the storing unit.

A read-only memory (ROM) 106 is a storage device in which a boot processing program of the image forming apparatus 100 is stored. The ROM 106 is an example of the storing unit.

A network interface (I/F) 102 is an interface for communicating with other apparatuses such as a host computer via an external network.

An operation unit 109 is a user interface that can display a status of the image forming apparatus 100 and accept an input about a user's instruction to the image forming apparatus 100.

An engine I/F 105 performs communications with and control of a printer engine 107.

The printer engine 107 forms an image on a physical sheet surface, for example, by using an electrophotographic technique or an inkjet image forming technique.

A software configuration of the image forming apparatus 100 according to an exemplary embodiment will be described below.

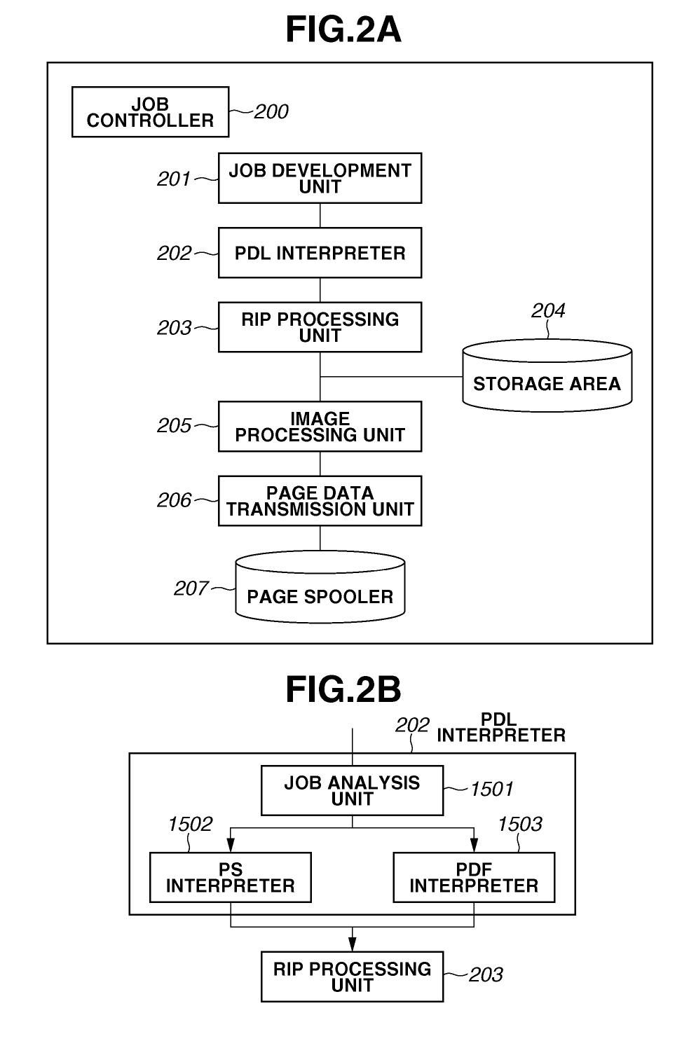

FIG. 2A is a diagram illustrating an example software configuration of the image forming apparatus 100.

As described above, each software module is implemented by the CPU 101 loading a program stored in the HDD 104 into the RAM 103 and executing the program.

A job development unit 201 develops a print job received via the network I/F 102.

A PDL interpreter 202 interprets PDL data (hereinafter, referred to as print data) included in the developed print job page by page, and converts the print data into an intermediate data format. FIG. 2B illustrates a detailed internal configuration of the PDL interpreter 202. A job analysis unit 1501 analyzes the PDL data received from the job development unit 201, and performs processing for passing the PDL to an appropriate interpreter. More specifically, the job analysis unit 1501 analyzes the contents of the PDL data. If a PDL type is determined to be PostScript® (PS), the job analysis unit 1501 passes the PDL data to a PS interpreter 1502. If the PDL type is determined to be Portable Document Format (PDF) data, the job analysis unit 1501 passes the PDL data to a PDF interpreter 1503.

There are PDL data of a page dependent type and PDL data of a page independent type. PS data is PDL data of the page dependent type, which needs to be interpreted in order from the first page. PDF data is PDL data of the page independent type, in which pages can be independently interpreted without interpreting the first page.

A raster image processor (RIP) processing unit 203 receives the converted intermediate data format and performs RIP processing to generate image data (hereinafter, referred to simply as image) page by page. When using a print method such as stored printing, the RIP processing unit 203 successively stores the images into a storage area 204 page by page. The storage area 204 may be implemented on the RAM 103. The storage area 204 may be implemented on the HDD 104. The storage area 204 may be an external storage device connected by the network I/F 102. In an exemplary embodiment, an image refers to data (page data) generated for each page, such as a bitmap image of a page.

An image processing unit 205 performs image processing on the generated image. Examples of the image processing include calibration and color conversion.

A page data transmission unit 206 stores the generated image-processed image into a page spooler 207 and transmits the stored image to the printer engine 107. The page data transmission unit 206 can directly transmit the image to the printer engine 107. The page spooler 207 may be implemented on the RAM 103 or the HDD 104.

The job development unit 201, the PDL interpreter 202, the RIP processing unit 203, the image processing unit 205, and the page data transmission unit 206 may be implemented in the image processing apparatus 100 as hardware. A job controller 200 can control the job development unit 201, the PDL interpreter 202, the RIP processing unit 203, the image processing unit 205, and the page data transmission unit 206 in a centralized manner.

A PDL error will be described below.

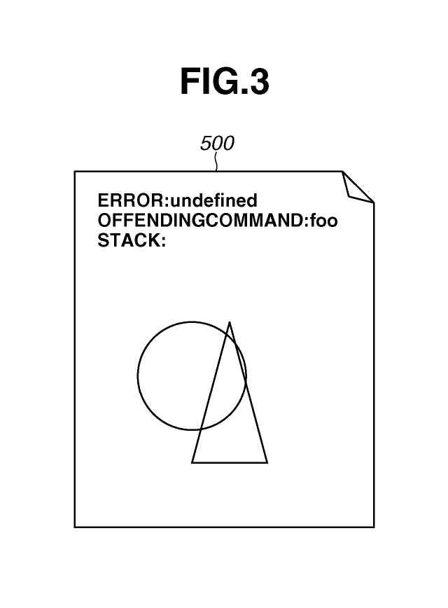

If an error occurs during interpretation of print data, the PDL interpreter 202 can output a message about an error state. For example, a printer equipped with PostScript® adds error information to an image of an error page (hereinafter, referred to simply as an error page) where the error has occurred, and prints out the resulting error page. More specifically, as illustrated in FIG. 3, the printer adds error information including a command causing the error, details of the error, and a stack at that point in time to the error page, and prints out the error page. The PDL error is an example of an interpretation error.

FIG. 3 illustrates an example error page to which error information is added.

Stored printing will be described below.

Methods for outputting a print job other than a normal print method include a stored printing output method.

When the image forming apparatus 100 performs printing by the normal printing output method (hereinafter, referred to simply as normal printing), the image forming apparatus 100 interprets print data to generate an image. The image forming apparatus 100 then sequentially transmits the image to the page spooler 207 without storing the image in the storage area 204, and performs printing by using the printer engine 107.

When using the stored printing output method (hereinafter, referred to simply as stored printing), the image forming apparatus 100 stores the image generated by interpreting the print data into the storage area 204. The image forming apparatus 100 does not make a print output in conjunction with such storing. The image forming apparatus 100 can print out the image, for example, based on the user's print instruction accepted via the operation unit 109. The image forming apparatus 100 does not delete the image in the storage area 204 even after the first print output. Accordingly, if the image forming apparatus 100 receives the user's instruction to print out the image for the second and subsequent times, the image forming apparatus 100 prints out the image stored in the storage area 204 again. In the stored printing, the image stored in the storage area 204 is printed out by the printer engine 107 in accordance with the user's print instruction.

According to the stored print method, images can be printed not only by the image forming apparatus 100 that stores the images, but also by other image forming apparatuses 100 connected by the network I/F 102. In such a case, the images are duplicated and printed via the network I/F 102 according to instructions from the other image forming apparatuses 100.

The foregoing stored printing is an example of the stored print method.

RIP post-completion printing will be described below. RIP post-completion printing is another method for outputting a print job.

When performing printing by a RIP post-completion printing output method (hereinafter, referred to simply as RIP post-completion printing), the image forming apparatus 100 interprets all the print data to generate the images of all the pages. The image forming apparatus 100 then collectively transmits the images of all the pages to the page spooler 207, and performs printing by using the printer engine 107.

The RIP post-completion printing is an output method that takes into account the characteristic that the printer engine 107 is forced to have poor productivity unless a certain number of images or more are stored in the page spooler 207. The image forming apparatus 100 generates the images of all the pages before transmitting the images to the page spooler 207, whereby print output can be performed without stopping the printer engine 107. As employed herein, the productivity refers to, for example, the number of sheets of paper printed per minute (paper per minute).

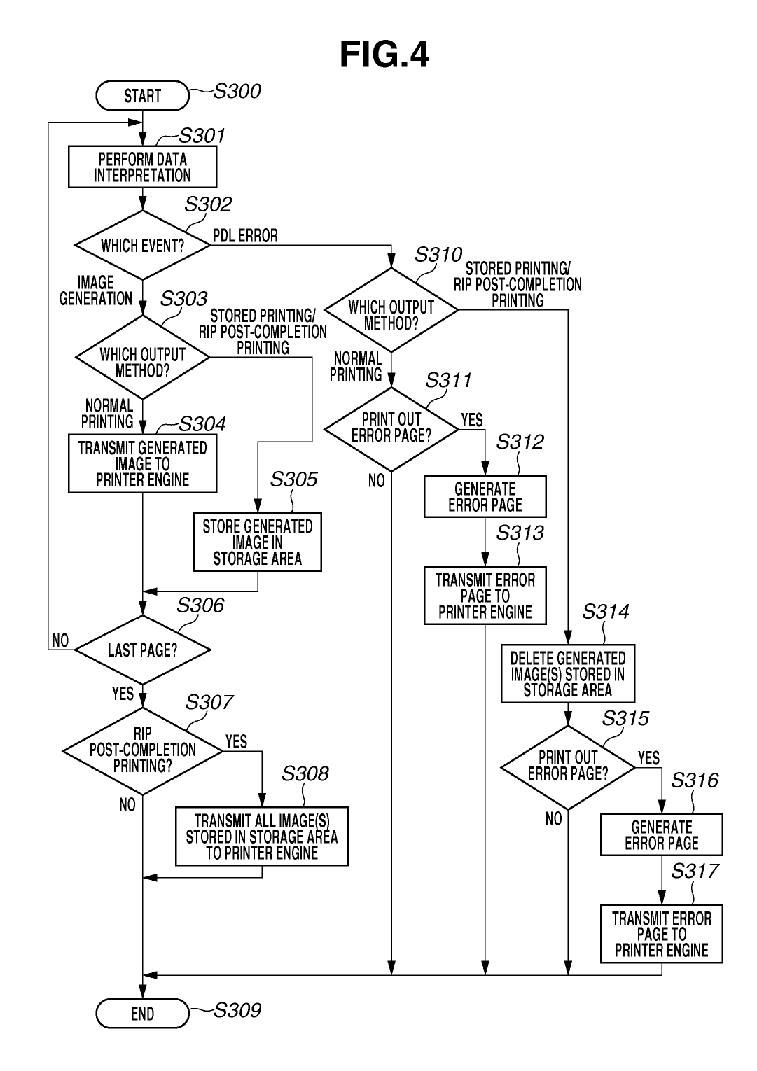

Processing of an exemplary embodiment will be described in detail below with reference to FIG. 4. FIG. 4 is an example flowchart of the processing according to an exemplary embodiment.

In S300, the job controller 200 receives a print job from the network I/F 102, and starts print processing.

In S301, the job controller 200 performs data interpretation of the print job received from the network I/F 102, and advances the processing to S302.

In S302, the job controller 200 generates an image based on the data interpreted in S301, and advances the processing to S303. In S302, if a PDL error is detected during the data interpretation of S301 (PDL ERROR in S302), the job controller 200 advances the processing to S310.

In S303, the job controller 200 determines an output method of the print job. More specifically, the job controller 200 determines the output method based on an output method setting (also referred to as a print method setting; the same applies below) which was input and set by the user via the operation unit 109. In S303, if the output method is determined to be the normal printing (NORMAL PRINTING in S303), the job controller 200 advances the processing to S304. In S303, if the output method is determined to be the stored printing or the RIP post-completion printing (STORED PRINTING/RIP POST-COMPLETION PRINTING in S303), the job controller 200 advances the processing to S305. In other words, the print data is interpreted in page order, and the generated image is successively output according to the determination of the output method.

The determination of the output method is an example of print method determination processing. The same applies below.

A case with the normal printing without a PDL error will be described below.

In S303, the job controller 200 determines that the output method is the normal printing (NORMAL PRINTING in S303), and advances the processing to S304.

In S304, the job controller 200 transmits the generated image to the page spooler 207 and then to the printer engine 107, and advances the processing to S306. Receiving the image, the printer engine 107 feeds paper and successively performs printing. The job controller 200 repeats the processing of S301 to S304 until the received print data reaches the last page.

In S306, the job controller 200 determines whether the print data is the last page. If the print data is determined to be the last page (YES in S306), the job controller 200 advances the processing to S307. In S306, if the print data is determined not to be the last page (NO in S306), the job controller 200 returns the processing to S301.

In S307, the job controller 200 determines whether the output method is the RIP post-completion printing. Since the output method here is the normal printing, the job controller 200 determines that the output method is not the RIP post-completion printing (NO in S307). In S309, the job controller 200 ends the print processing.

A case with the stored printing without a PDL error will be described below.

In S303, the job controller 200 determines that the output method is the stored printing (STORED PRINTING/RIP POST-COMPLETION PRINTING in S303), and advances the processing to S305.

In S305, the job controller 200 stores the generated image in the storage area 204, and advances the processing to S306.

In S306, the job controller 200 determines that the print data is the last page (YES in S306), and advances the processing to S307. In S307, the job controller 200 determines that the output method is not the RIP post-completion printing (NO in S307). In S309, the job controller 200 ends the print processing. Since the processing of S306, S307, and S309 is described above, a detailed description thereof is omitted here.

A case with the RIP post-completion printing without a PDL error will be described below.

In S303, the job controller 200 determines that the output method is the RIP post-completion printing (STORED PRINTING/RIP POST-COMPLETION PRINTING in S303), and advances the processing to S305.

In S305, the job controller 200 stores the generated image in the storage area 204, and advances the processing to S306.

In S306, the job controller 200 determines that the print data is the last page (YES in S306), and advances the processing to S307. In S307, the job controller 200 determines that the output method is the RIP post-completion printing (YES in S307), and advances the processing to S308. Since the processing of S306 and S307 is described above, a detailed description thereof is omitted here.

In S308, the job controller 200 transmits all the image(s) stored in the storage area 204 to the page spooler 207 and then to the printer engine 107. In S309, the job controller 200 ends the print processing.

Processing when the job controller 200 detects a PDL error in S302 will be described. In S302, the job controller 200 detects a PDL error (PDL ERROR in S302), and advances the processing to S310 as described above.

In S310, the job controller 200 determines the output method of the print job. If the output method is determined to be the normal printing (NORMAL PRINTING in S310), the job controller 200 advances the processing to S311. If the output method is determined to be the stored printing or the RIP post-completion printing (STORED PRINTING/RIP POST-COMPLETION PRINTING in S310), the job controller 200 advances the processing to S314. Since the processing of S310 is similar to that of S303, a detailed description thereof is omitted.

A case with the normal printing with a PDL error will be described below.

In S310, the job controller 200 determines that the output method is the normal printing (NORMAL PRINTING in S310), and advances the processing to S311.

In S311, the job controller 200 determines whether to print out an error page. More specifically, the job controller 200 determines whether to print out an error page based on an error page print setting. The error page print setting is input and set into the image forming apparatus 100 by the user's operation via the operation unit 109. The print output of the error page is an example of error page print processing. The same applies below.

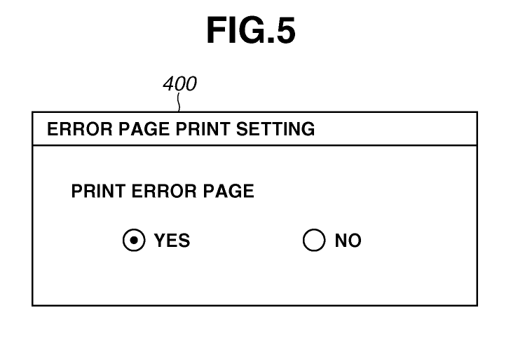

FIG. 5 is a diagram illustrating an example of an error page print setting screen displayed on the operation unit 109.

If the user wants to print out an error page, the user can input an error page print setting “YES” via the operation unit 109. If the user does not want to print out an error page, the user can input an error page print setting “NO.”

In S311, if the error page print setting is “YES,” the job controller 200 determines to print out an error page (YES in S311), and advances the processing to S312. In S311, if the error page print setting is “NO,” the job controller 200 determines not to print out an error page (NO in S311), and then in S309, ends the print processing.

In S312, the job controller 200 generates an error page, and advances the processing to S313.

In S313, the job controller 200 transmits the error page generated in S312 to the printer engine 107 for print output. In S309, the job controller 200 ends the print processing.

In other words, if an error occurs during printing by the normal printing, the job controller 200 outputs the image(s) of the page(s) generated before the occurrence of the error. The job controller 200 determines whether to output the image of the page where the error occurred, depending on the error page print setting.

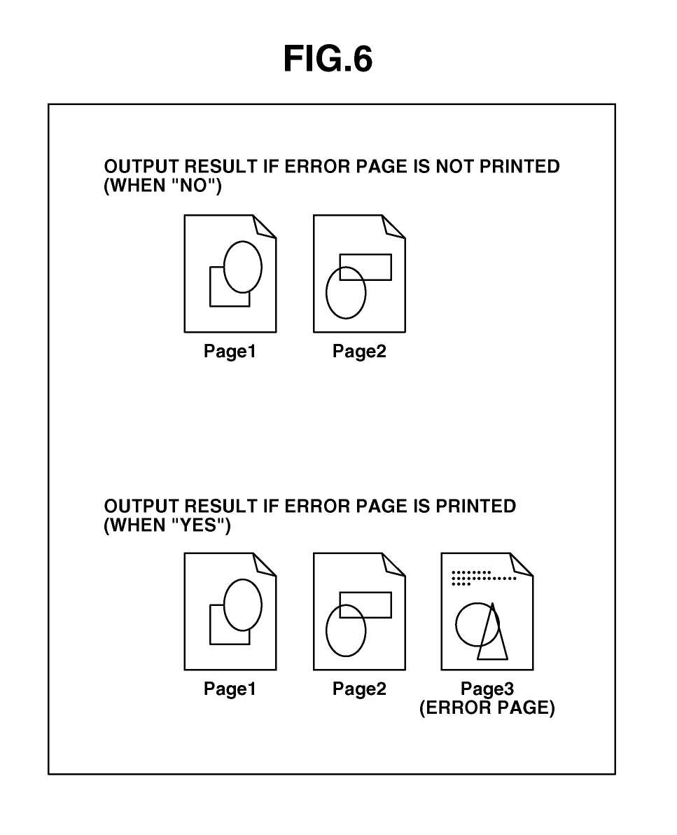

FIG. 6 illustrates an example of output results when the job controller 200 performs print output processing on a print job in which an error occurred in the third page of the print data.

Now, a case with the stored printing or RIP post-completion printing with a PDL error will be described.

In S310, the job controller 200 determines that the output method is the stored printing or the RIP post-completion printing (STORED PRINTING/RIP POST-COMPLETION PRINTING in S310), and advances the processing to S314.

In S314, the job controller 200 deletes the generated image(s) stored in the storage area 204, and advances the processing to S315. For example, if an error occurs during the interpretation of the third page, the job controller 200 deletes the images of the first and second pages stored in the storage area 204.

In S315, the job controller 200 determines whether to print out an error page. If the job controller 200 determines to print out the error page (YES in S315), the job controller 200 advances the processing to S316. If the job controller 200 determines not to print out the error page (NO in S315), then in S309, the job controller 200 ends the print processing. Since the processing of S315 is similar to that of S311, a detailed description thereof is omitted.

In S316, the job controller 200 generates the error page, and advances the processing to S317.

In S317, the job controller 200 transmits the error page generated in S316 to the printer engine 107 for printing. In S309, the job controller 200 ends the print processing.

In other words, if a PDL error occurs during printing by the stored printing or the RIP post-completion printing, the job controller 200 deletes the image(s) of the page(s) generated before the occurrence of the error. The job controller 200 then determines whether to output the error page according to the error page print setting.

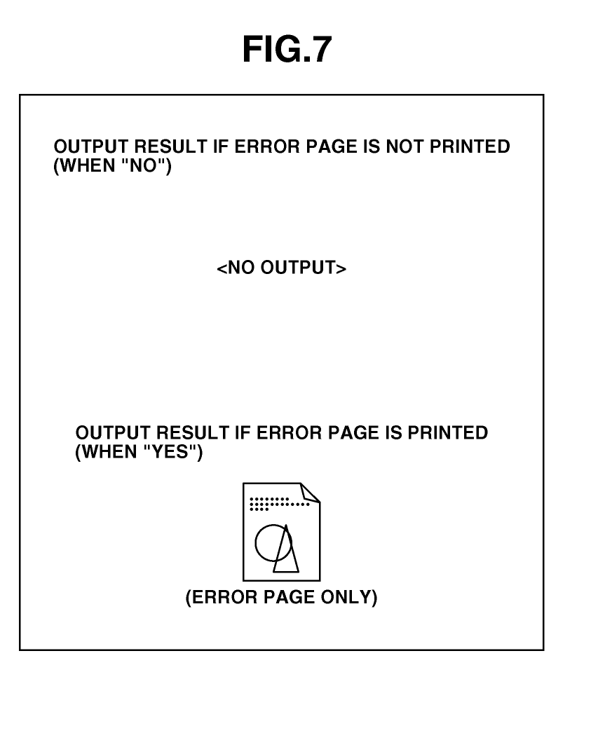

FIG. 7 is a diagram illustrating an example of output results when the job controller 200 outputs an error page and when not in the stored printing or the RIP post-completion printing.

If a PDL error occurs during the stored printing or the RIP post-completion printing, the job controller 200 can suppress output including the page(s) generated before the occurrence of the error.

As described above, according to an exemplary embodiment, if a PDL error occurs during printing by the stored printing or the RIP post-completion printing, the job controller 200 can delete the image(s) of the page(s) generated before the occurrence of the PDL error to suppress output. The job controller 200 can output only an error page according to the error page print setting. Consequently, the job controller 200 can save user's trouble of deleting the page(s) and discarding an output sheet(s).

In the foregoing exemplary embodiment, the job controller 200 performs the same processing regardless of the PDL type. The job controller 200 may be configured to delete images upon the occurrence of an error during the stored printing or the RIP post-completion printing only if the PDL type is PS. The reason is as follows. PS data is PDL data of the page dependent type so that the job controller 200 cannot interpret pages after the occurrence of an error, and can only obtain some pages before the occurrence of the error. In the case of PDL (here, PDF) data of the page independent type, the job controller 200 can interpret pages after the occurrence of an error, and can use all the pages except the one where the error occurred.

In the example described in the first exemplary embodiment, if a PDL error occurs during printing by the stored printing or the RIP post-completion printing, the job controller 200 deletes the image(s) of the page(s) generated before the occurrence of the PDL error to suppress output, and outputs only an error page. However, the user sometimes does not want to suppress the output of the image(s) of the page(s) generated before the occurrence of a PDL error, or the user sometimes wants to switch the output destination of the error page. An exemplary embodiment deals with processing in such cases.

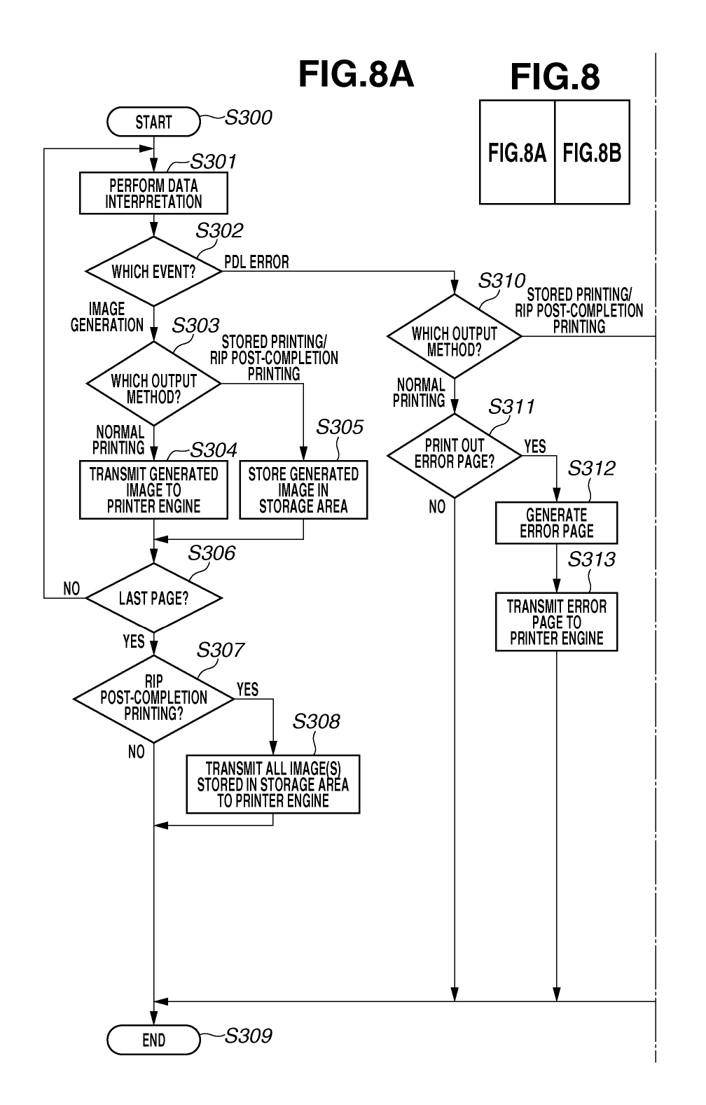

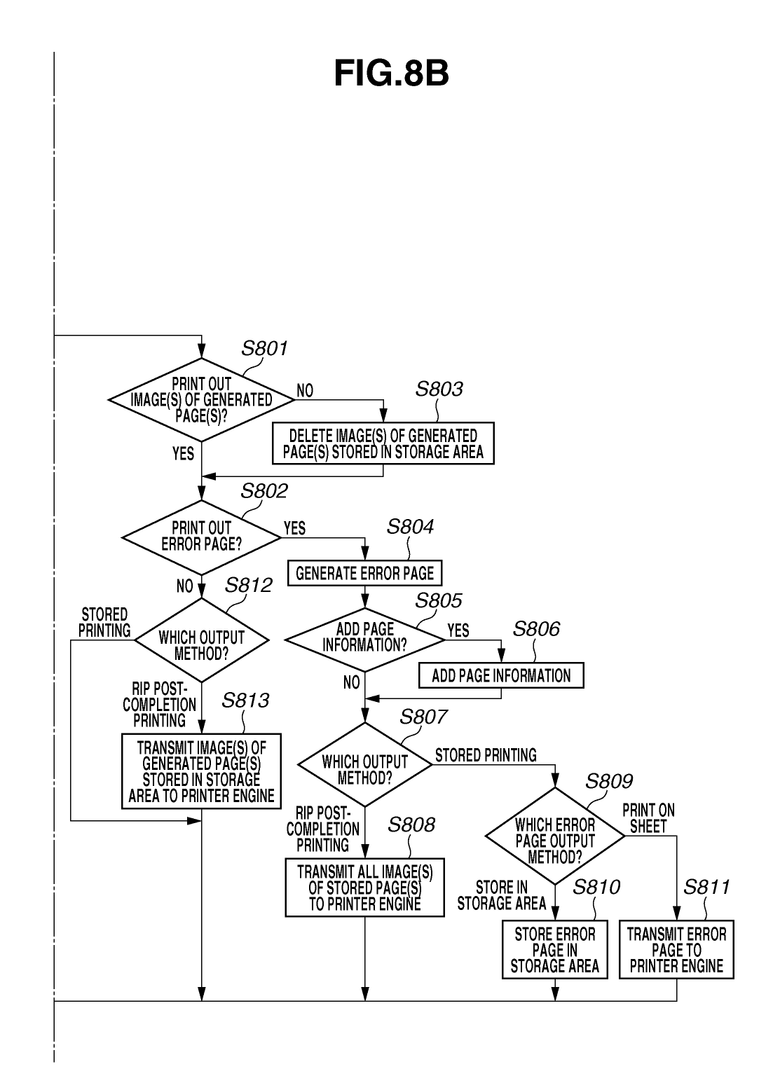

The processing of an exemplary embodiment will be described in detail below with reference to FIG. 8.

FIG. 8 is an example flowchart of the processing according to an exemplary embodiment.

The processing of S300 to S313 in FIG. 8 is similar to that of S300 to S313 in FIG. 4. A description thereof is thus omitted.

In S310, the job controller 200 determines that the output method of the print job is the stored printing or the RIP post-completion printing (STORED PRINTING/RIP POST-COMPLETION PRINTING in S310), and advances the processing to S801. In S801, the job controller 200 determines whether to print out the image(s) of the generated page(s). More specifically, the job controller 200 determines whether to print the generated page(s) based on a generated page print setting. The generated page print setting is set and input into the image forming apparatus 100 by the user's operation via the operation unit 109. In such a manner, the user can set into the image forming apparatus 100 whether to print generated pages if an error occurs during the stored printing or the RIP post-completion printing.

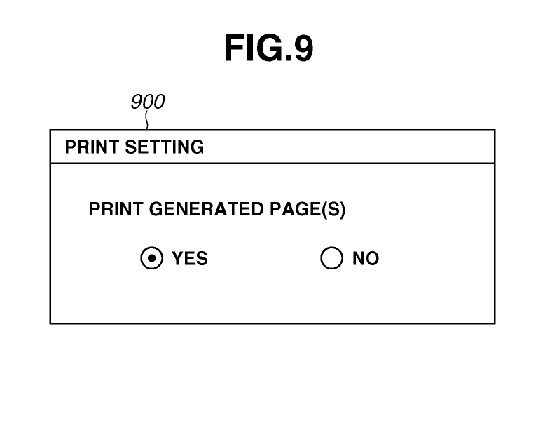

FIG. 9 illustrates an example print setting screen of a generated page displayed on the operation unit 109.

If the user wants to print out the images of generated pages, the user can input a generated page print setting “YES” via the operating unit 109. If the user does not want to print out the images of generated pages, the user can input a generated page print setting “NO.”

In S801, if the generated page print setting is “YES,” the job controller 200 determines to print out the image(s) of the generated page(s) (YES in S801), and advances the processing to S802. On the other hand, in S801, if the generated page print setting is “NO,” the job controller 200 determines not to print out the image(s) of the generated page(s) (NO in S801), and advances the processing to S803. In S803, the job controller 200 deletes the image(s) of the generated page(s) stored in the storage area 204.

In such a manner, even when a PDL error occurs during the stored printing or the RIP post-completion printing, the job controller 200 can print out the image(s) of the generated page(s) if the user wants to.

In S802, the job controller 200 determines whether to print out an error page. If the job controller 200 determines to print out the error page (YES in S802), the job controller 200 advances the processing to S804. If the job controller 200 determines not to print out the error page (NO in S802), the job controller 200 advances the processing to S812. Since the processing of S802 is similar to that of S311, a detailed description thereof is omitted.

In S812, the job controller 200 determines the output method of the print job. If the output method is determined to be the stored printing (STORED PRINTING in S812), then in S309, the job controller 200 ends the print processing. On the other hand, in S812, if the output method is determined to be the RIP post-completion printing (RIP POST-COMPLETION PRINTING in S812), the job controller 200 advances the processing to S813. In S813, the job controller 200 transmits the image(s) of the generated page(s) stored in the storage area 204 to the printer engine 107 for printing. In S309, the job controller 200 ends the print processing. In S812, as in S303 and S310, the job controller 200 determines the output method based on the output method setting input and set by the user via the operation unit 109.

In S804, the job controller 200 generates the error page, and advances the processing to S805.

In S805, the job controller 200 determines whether to add page information to the error page. More specifically, the job controller 200 determines whether to add page information to the error page based on an error page page information addition setting. The error page page information addition setting is a setting, which is input into the image forming apparatus 100 by the user's operation via the operation unit 109, as to whether to add page information to the error page.

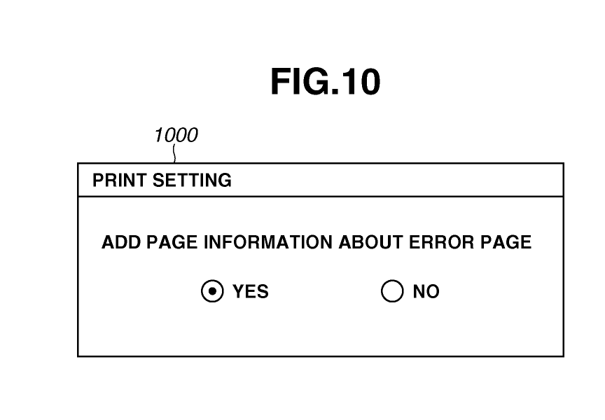

FIG. 10 illustrates an example of a setting screen of a page information addition setting of an error page displayed on the operation unit 109.

In S805, if the page information addition setting of the error page is “YES,” the job controller 200 determines to add page information to the error page (YES in S805), and advances the processing to S806. In S805, if the page information addition setting of the error page is “NO,” the job controller 200 determines not to add page information to the error page (NO in S805), and advances the processing to S807.

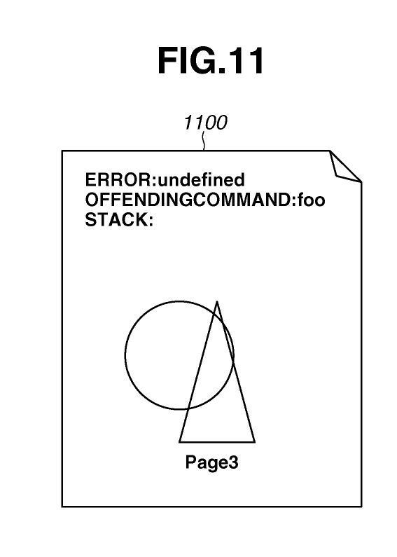

FIG. 11 illustrates an example of an error page to which page information is added.

FIG. 3 illustrates an example of the error page to which page information is not added. A comparison between FIGS. 3 and 11 shows that the characters “Page 3” are displayed as page information in FIG. 11.

If a PDL error occurs, the job controller 200 usually prints out the page(s) generated before the occurrence of the PDL error, as well as an error page. The user can thus easily check the page number of the page causing the PDL error. In an exemplary embodiment, the job controller 200 deletes the image(s) of the page(s) generated before the occurrence of the PDL error during the stored printing or the RIP post-completion printing. In such a case, it is difficult for the user to check the page number where the error page occurred in the data. The job controller 200 then performs the foregoing processing for adding the page information to the error page, whereby the user can easily check the page number of the page causing the PDL error in the data.

In S807, the job controller 200 determines the output method of the print job. If the output method is determined to be the RIP post-completion printing (RIP POST-COMPLETION PRINTING in S807), the job controller 200 advances the processing to S808. In S808, the job controller 200 transmits all the image(s) of the stored page(s) to the printer engine 107 for printing. In S309, the job controller 200 ends the print processing. On the other hand, in S807, if the output method is determined to be the stored printing (STORED PRINTING in S807), the job controller 200 advances the processing to S809. Since the processing of S807 is similar to that of S812, a detailed description thereof is omitted.

In S809, the job controller 200 determines the output method of the error page in the stored printing. More specifically, the job controller 200 determines the output method of the error page based on an error page output method setting in the stored printing. The error page output method setting in the stored printing is a setting that is input and set into the image forming apparatus 100 by the user's operation via the operation unit 109 and intended to switch the output method of the error page.

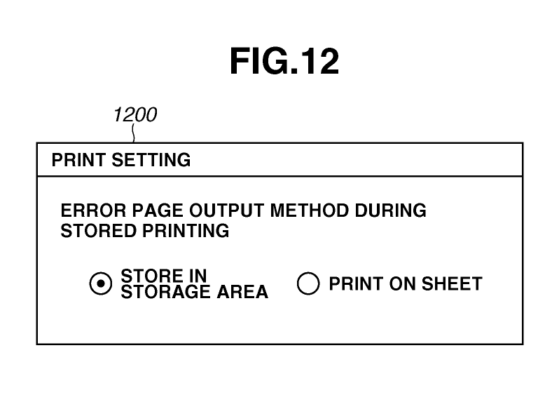

FIG. 12 is a diagram illustrating an example of an error page output method setting screen in the stored printing displayed on the operation unit 109.

In S809, if the error page output method setting in the stored printing is to “store in the storage area” (STORE IN STORAGE AREA in S809), the job controller 200 determines to store the error page in the storage area 204, and advances the processing to S810. On the other hand, in S809, if the error page output method setting in the stored printing is to “print on a sheet” (PRINT ON SHEET in S809), the job controller 200 determines to print only the error page, and advances the processing to S811.

In S810, the job controller 200 stores image(s) of the error page in the storage area 204 like the generated page(s). In S309, the job controller 200 ends the print processing.

In S811, the job controller 200 transmits only the error page to the printer engine 107 for printing. In S309, the job controller 200 ends the print processing.

In such a manner, if a PDL error occurs during the stored printing, the job controller 200 can print out only the error page so that the user can see it easily.

As described above, according to an exemplary embodiment, if a PDL error occurs during the stored printing or the RIP post-completion printing, the job controller 200 switches various settings based on the user's operations via the operation unit 109. This can improve the user's convenience. More specifically, the job controller 200 can switch whether to output the image(s) of the generated page(s), the output method of an error page, and the output form of the error page such as whether to add page information according to the user's intentions, thereby improving the user's convenience.

An exemplary embodiment deals with an exemplary embodiment other than the processing described in the first and second exemplary embodiments.

The CPU 101 of the image forming apparatus 100 can display the results of print output of processed print jobs on the operation unit 109 as a job history screen. The user can thus check the results of print output of the print jobs executed by the image forming apparatus 100 via the operation unit 109.

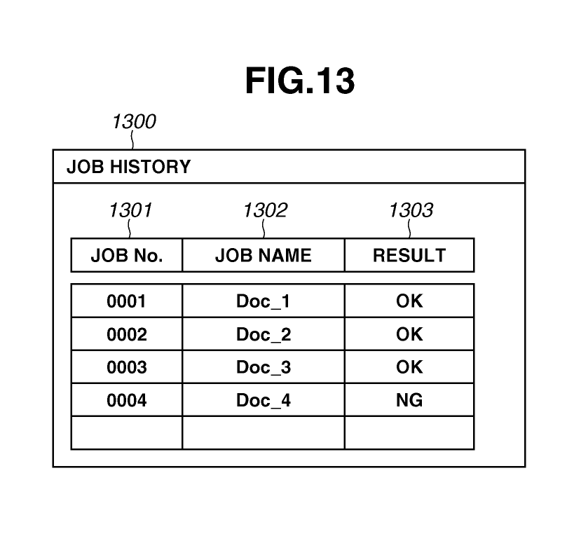

FIG. 13 is a diagram illustrating an example of the job history screen displayed on the operation unit 109.

The job history screen 1300 includes display fields of a job No. 1301, a job name 1302, and a result 1303. The display field of the result 1303 displays “OK” if the print job has been properly processed, and “NG” if an error has occurred.

The user can thus check the job history screen as to whether an error has occurred.

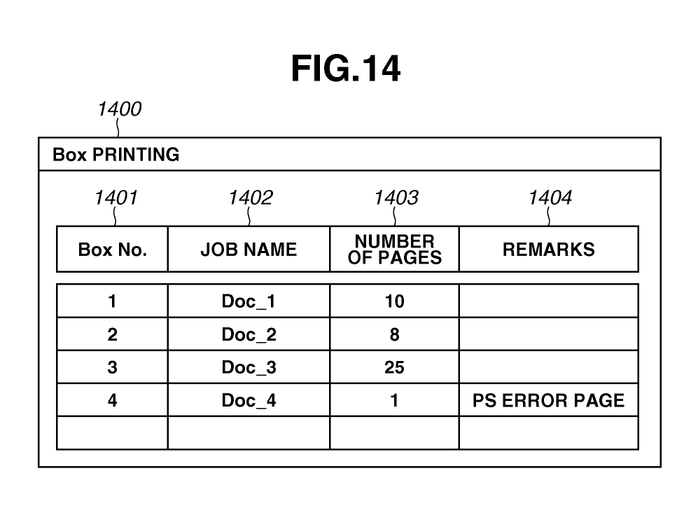

FIG. 14 is a diagram illustrating an example of a print job screen in the stored printing, which is displayed on the operation unit 109.

A stored printing screen 1400 includes display fields of a Box No. 1401, a job name 1402, the number of pages 1403, and remarks 1404. The display field of the number of pages 1403 displays the number of stored images. The display field of the remarks 1404 displays a comment when the print job is submitted to the stored printing. For example, if an error occurs during the stored printing, the corresponding display field of the remarks 1404 displays “ERROR PAGE.” The display field of the remarks 1404 may display detailed contents causing the error. The information displayed on the stored printing screen 1400 is an example of image list information in the stored printing.

In such a manner, the user can easily determine from the print job screen that the stored image is not a normal one but the image of an error page. This improves convenience to the user.

An exemplary embodiment may be implemented by executing the following processing. The processing includes providing software (program or programs) for implementing the functions of the foregoing exemplary embodiment to a system or an apparatus via a network or various storage media, and reading and executing the program(s) by a computer (or CPU or micro processor unit (MPU)) of the system or apparatus.

As has been described, according to the foregoing exemplary embodiments, the job controller 200 can save the user's trouble of having to delete the stored data of already generated pages when a PDL error occurs in a print method such as the stored printing. The job controller 200 can also provide print output convenient to the user by switching various settings based on the user's operations via the operation unit 109.

While the exemplary embodiments of the present subject matter have been described in detail above, the exemplary embodiments are not limited to such specific ones. Various changes and modifications may be made without departing from the gist of an exemplary embodiment of the present subject matter set forth in the claims.

According to an exemplary embodiment of the present subject matter, it is possible to save the user's trouble of having to delete the stored data of already generated pages when a PDL interpretation error occurs in a print method such as the stored printing.

Embodiments of the present subject matter can also be realized by a computer of a system or apparatus that reads out and executes computer executable instructions recorded on a storage medium (e.g., non-transitory computer-readable storage medium) to perform the functions of one or more of the above-described embodiment(s) of the present subject matter, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present subject matter has been described with reference to exemplary embodiments, it is to be understood that the subject matter is not limited to the disclosed exemplary embodiments. The scope of the following claims is to be accorded the broadest interpretation so as to encompass all such modifications and equivalent structures and functions.

This application claims the benefit of Japanese Patent Application No. 2013-040461 filed Mar. 1, 2013, which is hereby incorporated by reference herein in its entirety.

What is claimed is:

1. An image forming apparatus configured to utilize a storage area to store an image, the apparatus comprising:
a receiving unit configured to receive print job data for which a predetermined print method configured to enable a stored image to be printed according to a print instruction given for the image by a user after the image is stored in the storage area is designated as a print method;
a generating unit configured to generate an image of a page from the print job data; and
a storing unit configured to store the generated image of the page into the storage area so that the stored image of the page is printed according to the print instruction,
wherein the storing unit is configured to, if the generating unit fails to generate an image of a page from the print job data, control an image of another page that the generating unit successfully generates from the print job data so that the image of the other page is not printed.

2. The apparatus according to claim 1, wherein the generating unit is configured to generate an image of a page from the print job data, and the storing unit is configured to store the generated image of the page into the storage area, page by page in succession.

3. The apparatus according to claim 2,
wherein the generating unit is configured to, if the generating unit fails to generate an image of a page from the print job data, not generate an image of a subsequent page of the page where the generating unit fails to generate an image, and
wherein the storing unit is configured to, if the generating unit fails to generate an image of a page from the print job data, control an image of a page already stored in the storage area by the storing unit so that the image of the page already stored is not printed.

4. The apparatus according to claim 1, wherein the generating unit comprises:
an interpreting unit configured to interpret the print job data; and
a judging unit configured to, if the interpreting unit fails to interpret the print job data, judge that an image of a page fails to be generated from the print job data.

5. The apparatus according to claim 1, further comprising a display unit configured to, if the generating unit fails to generate an image of a page from the print job data, display information indicating that the print job data is not printable.

6. The apparatus according to claim 1, wherein the print job data is PostScript (PS) data.

7. The apparatus according to claim 1, further comprising a determining unit configured to determine whether the print job data is of a page dependent type or a page independent type,
wherein the storing unit is configured to
if the generating unit fails to generate an image of a page from the print job data and the determining unit determines that the print job data is of the page dependent type, control the image of the another page that the generating unit successfully generates from the print job data so that the image of the another page is not printed, and
if the generating unit fails to generate an image of a page from the print job data and the determining unit determines that the print job data is of the page independent type, control the image of the another page that the generating unit successfully generates from the print job data so that the image of the another page is printed.

8. The apparatus according to claim 7, wherein the print job data of the page dependent type is PostScript (PS) data, and the print job data of the page independent type is Portable Document Format (PDF) data.

9. The apparatus according to claim 1, wherein the storing unit is configured to, if the generating unit fails to generate an image of a page from the print job data, perform deletion processing on an image of another page that the generating unit successfully generates from the print job data.

10. The apparatus according to claim 1, further comprising:
a decision unit configured to decide whether the print method designated for the print job data is another print method different from the predetermined print method,
wherein the another print method is configured to enable an image of a page generated by the generating unit to be printed without being stored in the storage area and without the print instruction,
wherein the generating unit is configured to, if the decision unit decides that the print method designated for the print job data is the another print method, generate an image of a page from the print job data, and
wherein if the generating unit fails to generate an image of a page from the print job data, an error page including information about the failure is printed.

11. The apparatus according to claim 10, wherein the information about the failure is information about a command causing the failure.

12. The apparatus according to claim 1, wherein the storage area is provided in the apparatus.

13. The apparatus according to claim 1, wherein the storage area is provided outside the apparatus.

14. The apparatus according to claim 1, wherein the predetermined print method is a print method configured to continue storing the image to be printed in the storage area so that the image to be printed is printable according to another print instruction given for the image by a user after the preceding print instruction for the image.

15. The apparatus according to claim 14, wherein the predetermined print method is configured to enable the stored image to be printed by a printing apparatus according to a print instruction given for the image by a user after the image is stored in the storage area.

16. The apparatus according to claim 1 further comprising a printer engine to print an image.

17. An image forming method configured to utilize a storage area to store an image, the method comprising:
receiving print job data for which a predetermined print method is designated as a print method;
generating an image of a page from the print job data; and
storing the generated image of the page into the storage area so that the stored image of the page is printed according to the print instruction,
wherein the predetermined print method is configured to enable a stored image to be printed according to a print instruction given for the image by a user after the image is stored in the storage area, and
wherein the storing is configured to include, if the generating fails to generate an image of a page from the print job data, controlling an image of another page that the generating successfully generates from the print job data so that the image of the another page is not printed.

18. A non-transitory computer readable medium storing instructions for executing an image forming method using a storage area, the method comprising:
receiving print job data for which a predetermined print method is designated as a print method;
generating an image of a page from the print job data; and
storing the generated image of the page into the storage area so that the stored image of the page is printed according to the print instruction,
wherein the predetermined print method enables a stored image to be printed according to a print instruction given for the image by a user after the image is stored in the storage area, and
wherein the storing is configured to include, if the generating fails to generate an image of a page from the print job data, controlling an image of another page that the generating successfully generates from the print job data so that the image of the another page is not printed.
